(19) United States
(12) Patent Application Publication
(10) Pub. No.: US 2024/0383392 A1
(43) Pub. Date: Nov. 21, 2024

(54) RECONFIGURABLE BED SYSTEM

(71) Applicant: Ember Recreational Vehicles, Inc., Elkhart, IN (US)

(72) Inventors: Christopher Julius Barth, Bristol, IN (US); Spencer Charles Brown, Goshen, IN (US); Austin Timothy Borg, Goshen, IN (US); Darrell Dee Yoder, Shipshewana, IN (US)

(21) Appl. No.: 18/666,585

(22) Filed: May 16, 2024

Related U.S. Application Data
(60) Provisional application No. 63/502,489, filed on May 16, 2023.

(51) Int. Cl. B60N 3/00; A47C 17/80; A47C 19/20

(52) U.S. Cl. CPC B60N 3/008; A47C 17/80; A47C 19/20

(57) ABSTRACT

A reconfigurable, modular bed system for use in recreational vehicles. The system includes one or more bed platforms that can support a mattress and can be repositioned or removed as desired. The bed platforms are vertically supported by a vertical track system that is secured to one or more walls in the recreational vehicle. The track system comprises a plurality of vertical tracks having a plurality of aligned openings to receive various brackets. The brackets are designed with upper and lower extensions for hooking into any of the openings in the rails. The bed platforms can be used as a desk, workbench, or other work surface when the mattress is removed. The system provides a multitude of ways to customize or reconfigure the space based on the end user's requirements.

### CROSS REFERENCE TO RELATED APPLICATION

This application claims priority to U.S. Application No. 63/502,489, filed May 16, 2023, which is hereby incorporated by reference in its entirety.

### BACKGROUND OF THE INVENTION

### 1. Field of the Invention

The present disclosure relates to space optimization systems for confined living spaces, and more particularly to a reconfigurable, modular bed system for use in recreational vehicles.

### 2. Description of the Prior Art

In the realm of recreational vehicles, particularly travel trailers, space optimization is a paramount concern. Recreational vehicles are designed to provide a comfortable living environment within a compact, mobile structure. As such, the interior layout and design of recreational vehicles often require innovative solutions to maximize the utility of the limited space available.

One of the primary components of a recreational vehicle's interior is the sleeping area or bed system. Traditional bed systems in recreational vehicles are typically fixed in place, occupying a substantial portion of the interior space. These fixed bed systems are often limited in their adaptability, restricting the use of the space to specific functions, primarily sleeping.

In addition to sleeping arrangements, recreational vehicle users often require other functional spaces, such as workspaces or storage areas. To address this, some bed systems have been designed to serve multiple functions. For example, a bed platform may be designed to function as a desk or workbench when a mattress is removed. However, the adjustability and reconfigurability of such systems can be limited.

In summary, there remains a lack of solutions that fully address the requirements for space optimization, adaptability, and reconfigurability in such environments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a reconfigurable, modular bed system is provided for use in recreational vehicles. The system includes one or more bed platforms that can support a mattress and can be repositioned or removed as desired. The bed platforms are vertically supported by a vertical track system that is secured to one or more walls in the recreational vehicle. The track system comprises a plurality of vertical tracks having a plurality of aligned openings to receive various brackets. The brackets are designed with upper and lower extensions for hooking into any of the openings in the rails. The bed platforms can be used as a desk, workbench, or other work surface when the mattress is removed. In addition, the bed can be provided as a single bed or it can be provided as a double bed having two bed platforms.

According to other aspects of the present disclosure, the bed system may include one or more vertical columns instead of one or more of the wall-mounted track rails. The vertical column provides support to the bed system in the same manner as wall-mounted track rails, except that the vertical column is supported at the ceiling and the floor of the recreational vehicle rather than along a wall of the recreational vehicle. Each column is an elongated post which has a hollow interior. The column includes the aligned openings for receiving the bracket, which is the same as the wall-mounted track rails. The column includes a lower end which is secured within a socket, opening, or recess within the floor of the recreational vehicle. Likewise, the upper end of each post includes an adjustable inner post which is complementary and sized to fit within the opening of the column. The inner post slides upward or downward within the post to selectively adjust the height of the column.

According to another embodiment of the disclosure, the bed system includes a pair of vertically aligned track Rails that are designed to be secured to a wall, with brackets attached at various heights to support the Bed Platforms. In this embodiment, there is provided a tube or beam that extends the full span between each aligned track rail. The tube or beam is provided instead of the bed support channels discussed elsewhere in this disclosure. The tube or beam is provided for structural purposes to provide support on which the bed platform is placed. The tube or beam is made from any material which is lightweight and high-strength, such as aluminum or a composite material.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 is an isometric view of a bed system installed within an interior space, according to aspects of the present disclosure;

FIG. 2 is an isometric view of a reconfigurable, modular bed system within an interior space, according to aspects of the present disclosure;

FIG. 3 is an isometric view of a bed system, according to aspects of the present disclosure;

FIG. 4 is an isometric view of a bed system, according to aspects of the present disclosure;

FIG. 5 is an exploded isometric view of a reconfigurable, modular bed system, according to aspects of the present disclosure;

FIG. 6 is an exploded isometric view of a modular bed system, according to aspects of the present disclosure;

FIG. 7 is an orthogonal view of a section of a track rail, according to aspects of the present disclosure;

FIG. 8 is an isometric view of a bracket engaged with a track rail, according to aspects of the present disclosure;

FIG. 9 is a partial isometric view of a track rail engaged with a bracket, according to aspects of the present disclosure;

FIG. 10 is an isometric view of a component of a reconfigurable, modular bed system, according to aspects of the present disclosure;

FIG. 11 is an isometric view of a modular bed system with vertically stacked bed platforms, according to aspects of the present disclosure;

FIG. 12 is an orthogonal front view of a vertical column for a modular bed system, according to aspects of the present disclosure;

FIG. 13 is orthogonal front views of a vertical column for a modular bed system, showing the adjustable inner post at three different heights, according to aspects of the present disclosure;

FIG. 14A is an isometric view of a spring pin, according to aspects of the present disclosure;

FIG. 14B is an isometric view of a spring pin, according to aspects of the present disclosure;

FIG. 15 is an isometric view of a portion of a reconfigurable, modular bed system, according to aspects of the present disclosure;

FIG. 16 is an isometric view of a stacked double bed configuration within a modular bed system, according to aspects of the present disclosure;

FIG. 17 is an exploded isometric view of a reconfigurable, modular bed system shown in a stowed-away configuration, according to aspects of the present disclosure;

FIG. 18 is an exploded isometric view of a modular bed system component, according to aspects of the present disclosure;

FIG. 19 is an isometric view of a portion of a reconfigurable, modular bed system, according to aspects of the present disclosure;

FIG. 20 is orthogonal front views of a two-piece column for a modular bed system, according to aspects of the present disclosure; and

FIG. 21 is an orthogonal front view of a two-piece column for a modular bed system, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a reconfigurable, modular bed system, particularly designed for use in recreational vehicles. In some aspects, the system may include one or more bed platforms that can support a mattress and can be repositioned or removed as desired. The bed platforms may be vertically supported by a vertical track system that is secured to one or more walls in the recreational vehicle. The track system may comprise a plurality of vertical tracks having a plurality of aligned openings to receive various brackets. The brackets may be designed with upper and lower extensions for hooking into any of the openings in the rails.

In some cases, the bed platforms can be used as a desk, workbench, or other work surface when the mattress is removed. This multi-functionality provides a more efficient use of space, a valuable feature in the confined space of a recreational vehicle. Furthermore, the system can accommodate both single and double bed configurations, offering further adaptability to the user's sleeping arrangement preferences.

In other aspects, the system may include one or more vertical columns instead of one or more of the wall-mounted track rails. The vertical column provides support to the bed system in the same manner as wall-mounted track rails, except that the vertical column is supported at the ceiling and the floor of the recreational vehicle rather than along a wall of the recreational vehicle.

In yet another embodiment, the bed system includes a tube or beam that extends the full span between each aligned track rail. The tube or beam is provided instead of the bed support channels discussed elsewhere in this disclosure. The tube or beam is provided for structural purposes to provide support on which the bed platform is placed.

Overall, the reconfigurable, modular bed system offers a more flexible, adaptable, and user-friendly solution for bed systems in recreational vehicles compared to existing alternatives. The system's design, which includes brackets with upper and lower extensions for hooking into any of the openings in the rails, allows for easy repositioning or removal of the bed platforms. This ease of adjustment provides a user-friendly solution not commonly found in the prior art.

As used herein, the term “recreational vehicle” broadly refers to and encompasses a variety of vehicles equipped with living quarters. This includes, but is not limited to, fifth wheel trailers, travel trailers, motor homes, pop-up campers, toy haulers, and any other type of vehicle designed to provide accommodation. The term is intended to cover a wide range of vehicles that offer amenities found in a home, which are typically used for leisure activities such as camping and road trips.

It is to be understood that, as referenced and discussed throughout this disclosure, the track system utilized for supporting and adjusting the bed platforms may be any type of commercially-available track system suitable for the intended application. This includes, but is not limited to, systems commonly known as “E-Track” or “L-Track.” These track systems are well-known in the industry for their versatility and reliability in securing and repositioning various components within a vehicle. The choice of track system may be based on factors such as load capacity, ease of use, compatibility with the vehicle structure, and user preference.

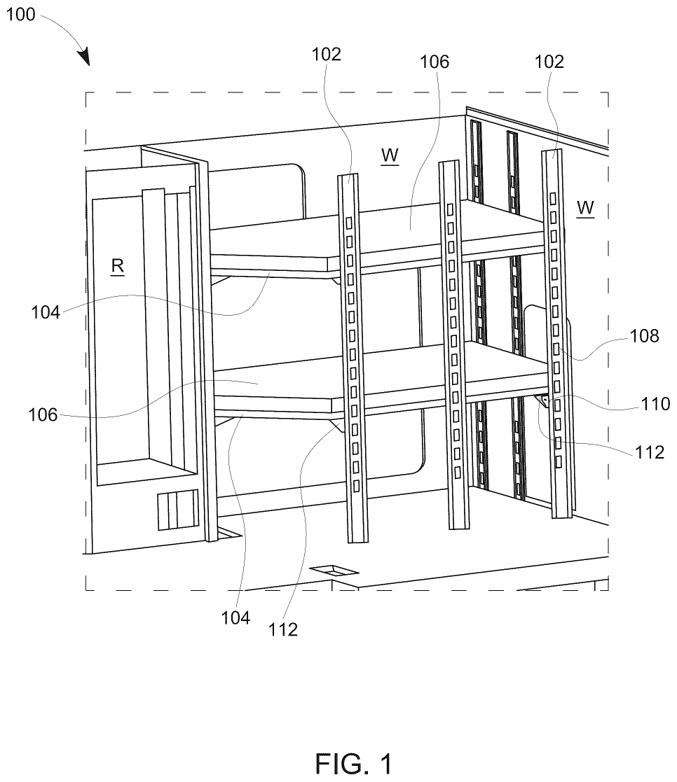

In some aspects, as depicted in FIG. 1, a bed system 100 may be installed within an interior space delineated by walls W of a recreational vehicle R. The bed system 100 may include track rails 102 that are vertically mounted to the walls W. The track rails 102 may feature multiple rail openings 108 that allow for the attachment of brackets 110. The brackets 110 may be designed to engage with the rail openings 108 on the track rails 102, thereby providing a mechanism for the adjustable positioning of bed platforms 104.

The bed platforms 104 may be horizontally positioned and supported by the brackets 110. In some cases, mattresses 106 may be placed on top of the bed platforms 104, indicating the system's use for sleeping arrangements. However, in other cases, the bed platform 104 may be used as a desk or work surface when the mattress 106 is removed. This provides a versatile use of the bed platform 104, allowing it to serve multiple functions depending on the user's requirements.

Additionally, support channels 112 may be connected to the brackets 110 and provide additional structural support to the bed platforms 104. The arrangement of the track rails 102, brackets 110, and support channels 112 allows for the vertical adjustability of the bed platforms 104 within the space. This feature provides flexibility in configuring the interior space of the recreational vehicle R, allowing for customization based on the user's preferences and requirements.

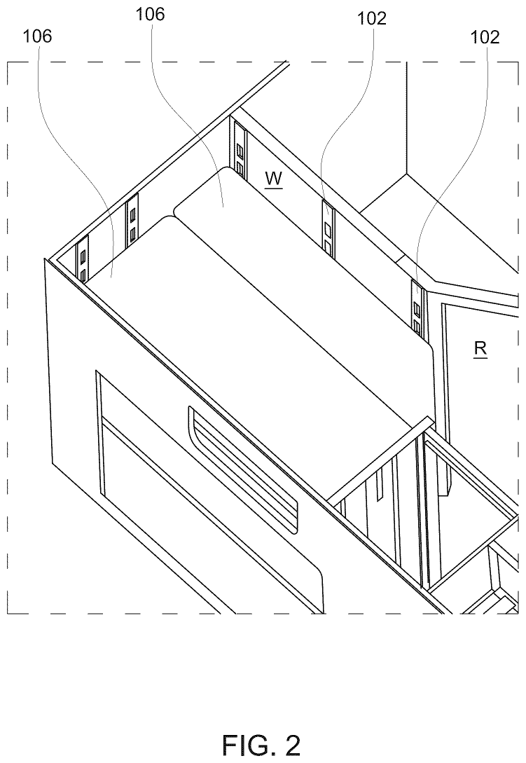

Referring to FIG. 2, an isometric view of a reconfigurable, modular bed system within an interior space of a recreational vehicle R is depicted. A mattress 106 is positioned on top of a bed platform 104, which is supported by track rails 102 mounted vertically on a W of the recreational vehicle R. The track rails 102 feature multiple aligned openings that allow for the adjustable positioning of the bed platform 104, demonstrating the system's adaptability and efficient use of space within the environment.

In some cases, the bed platform 104 can be provided as a single bed. In this configuration, the bed platform 104 is designed to support a single mattress 106, providing a sleeping arrangement suitable for one person. The bed platform 104 in this configuration may be positioned at any desirable height along the track rails 102, allowing for customization based on the user's preferences or requirements.

In other cases, the bed system 100 may include a double bed configuration having two bed platforms 104. Each bed platform 104 in this configuration is designed to support a mattress 106, providing a sleeping arrangement suitable for two people. The two bed platforms 104 may be positioned at the same or different heights along the track rails 102, allowing for further customization based on the user's preferences or requirements. The ability to provide both single and double bed configurations offers further adaptability to the user's sleeping arrangement preferences, enhancing the versatility of the bed system 100 within the recreational vehicle R.

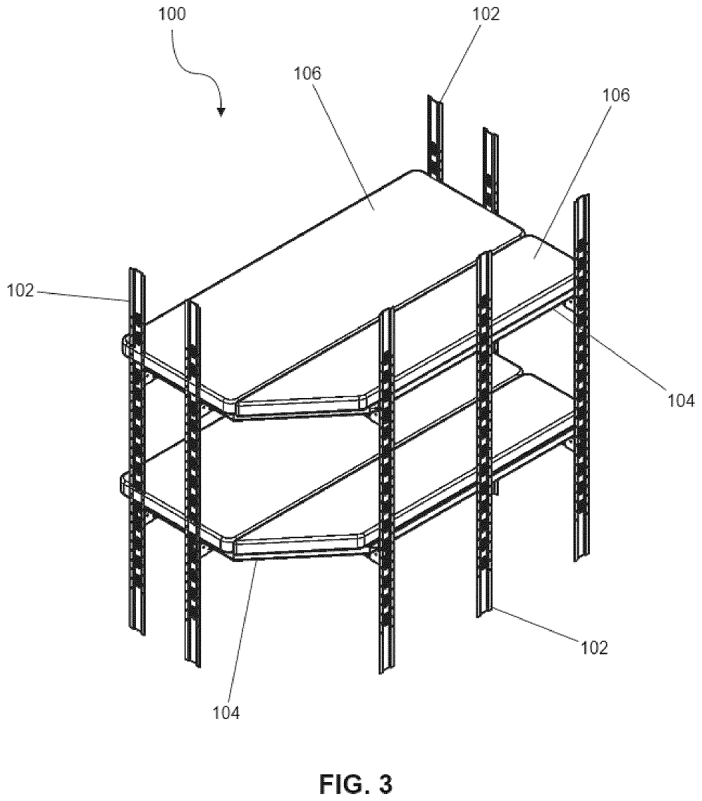

Referring now to FIG. 3, an isometric view of a bed system 100 is depicted. The bed system 100 includes track rails 102 that are vertically oriented and positioned on either side of a bed platform 104. The track rails 102 provide structural support to the bed platform 104 and allow for adjustable positioning of the bed platform 104 within a space, such as the interior of a recreational vehicle R.

The track rails 102 feature multiple aligned openings (not labeled in the figure) that are designed to receive brackets (not labeled in the figure). The brackets can be inserted into the aligned openings on the track rails 102, thereby providing a mechanism for the adjustable positioning of the bed platform 104. The brackets can be designed to engage with the aligned openings on the track rails 102, thereby providing a secure connection between the track rails 102 and the bed platform 104.

A mattress 106 is depicted resting on top of the bed platform 104, indicating one possible use of the bed system 100 for sleeping arrangements. However, in some cases, the bed platform 104 may be used for other purposes. For example, when the mattress 106 is removed, the bed platform 104 may be used as a desk or work surface. This demonstrates the versatility and adaptability of the bed system 100, as it can be reconfigured to serve multiple functions based on the user's requirements.

In some aspects, the bed system 100 may be designed to accommodate a variety of sleeping arrangements. For instance, the bed platform 104 may be positioned at a height suitable for use as a single bed. Alternatively, the bed system 100 may include multiple bed platforms 104, each designed to support a mattress 106, thereby providing a double bed configuration. The ability to adjust the positioning of the bed platform 104 along the track rails 102 allows for customization of the bed system 100 based on the user's preferences or requirements.

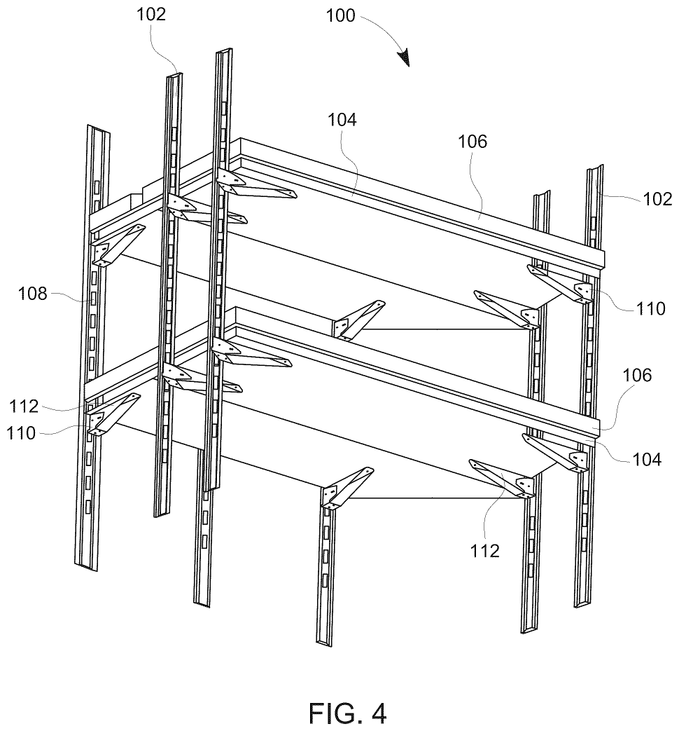

Referring now to FIG. 4, an isometric view of a bed system 100 is depicted. The bed system 100 includes track rails 102 that are vertically oriented and affixed to an unseen structure, such as a wall W of a recreational vehicle R. The track rails 102 feature multiple rail openings 108 that are designed to receive brackets 110. The brackets 110 are designed to engage with the rail openings 108 on the track rails 102, thereby providing a secure connection between the track rails 102 and the bed platform 104.

The bed platforms 104 are horizontally positioned and supported by support channels 112, which are connected to the brackets 110. The support channels 112 provide additional structural support to the bed platforms 104, enhancing the stability of the bed system 100. The arrangement of the track rails 102, brackets 110, and support channels 112 allows for the vertical adjustability of the bed platforms 104 within a space, such as the interior of a recreational vehicle R. This feature provides flexibility in configuring the interior space of the recreational vehicle R, allowing for customization based on the user's preferences or requirements.

Mattresses 106 are depicted resting on top of the bed platforms 104, indicating one possible use of the bed system 100 for sleeping arrangements. However, in some cases, the bed platform 104 may be used for other purposes. For example, when the mattress 106 is removed, the bed platform 104 may be used as a desk or work surface. This demonstrates the versatility and adaptability of the bed system 100, as it can be reconfigured to serve multiple functions based on the user's requirements.

In some aspects, the bed system 100 may be designed to accommodate a variety of sleeping arrangements. For instance, the bed platform 104 may be positioned at a height suitable for use as a single bed. Alternatively, the bed system 100 may include multiple bed platforms 104, each designed to support a mattress 106, thereby providing a double bed configuration. The ability to adjust the positioning of the bed platform 104 along the track rails 102 allows for customization of the bed system 100 based on the user's preferences or requirements.

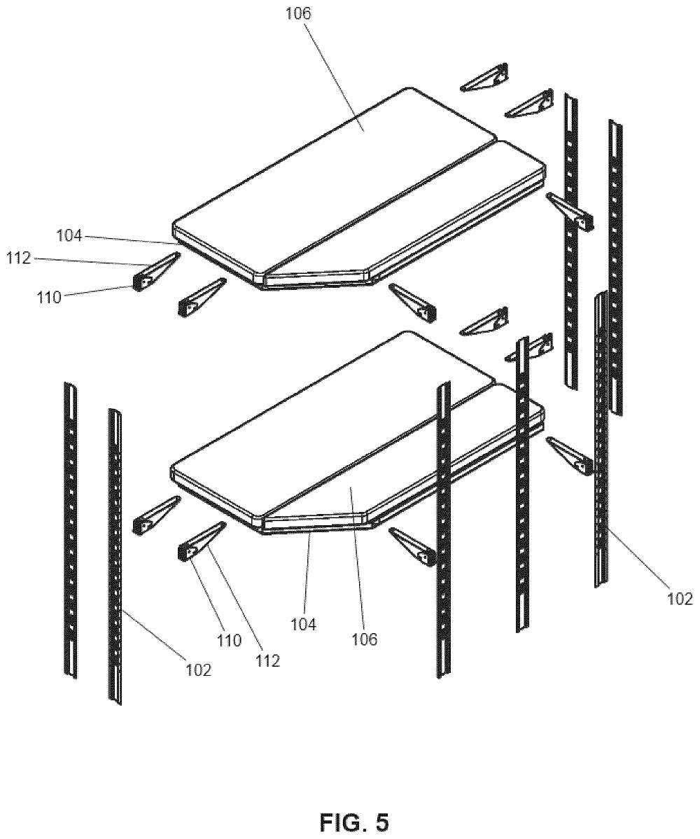

Referring now to FIG. 5, an exploded isometric view of a reconfigurable, modular bed system 100 is depicted. The bed system 100 may include track rails 102 that are designed to be mounted vertically on a wall W of a recreational vehicle R. The track rails 102 may feature multiple rail openings 108 that are designed to receive brackets 110. The brackets 110 may be designed to engage with the rail openings 108 on the track rails 102, thereby providing a secure connection between the track rails 102 and the bed platform 104.

In some aspects, bed platforms 104 may be shown in an elevated position, ready to be secured to the track rails 102 by brackets 110. The brackets 110 may engage with the openings on the track rails 102, thereby providing a mechanism for the adjustable positioning of the bed platforms 104. Mattresses 106 may be positioned on top of the bed platforms 104, indicating their potential use for sleeping arrangements. However, in other cases, the bed platform 104 may be used for other purposes, such as a desk or work surface when the mattress 106 is removed. This demonstrates the versatility and adaptability of the bed system 100, as it can be reconfigured to serve multiple functions based on the user's requirements.

Additionally, support channels 112 may be connected to the brackets 110 and provide additional structural support to the bed platforms 104. The support channels 112 may be designed to engage with the brackets 110, thereby providing a secure connection between the brackets 110 and the bed platform 104. The arrangement of the track rails 102, brackets 110, and support channels 112 allows for the vertical adjustability of the bed platforms 104 within the space. This feature provides flexibility in configuring the interior space of the recreational vehicle R, allowing for customization based on the user's preferences or requirements.

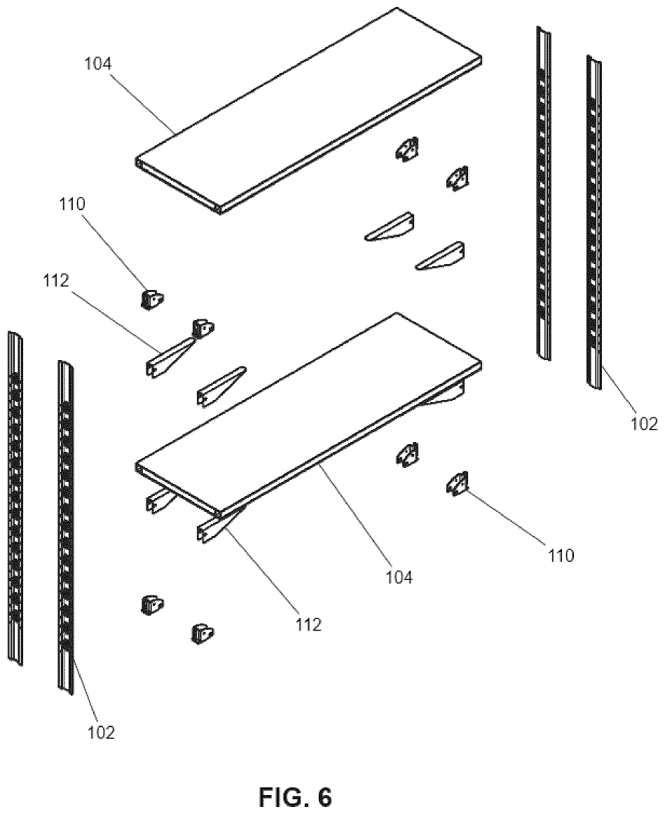

Referring now to FIG. 6, an exploded isometric view of a modular bed system component is depicted. The bed system 100 may include track rails 102 that are designed to be mounted vertically on a wall W of a recreational vehicle R. The track rails 102 may feature multiple rail openings 108 that are designed to receive brackets 110. The brackets 110 may be designed to engage with the rail openings 108 on the track rails 102, thereby providing a secure connection between the track rails 102 and the bed platform 104.

In some aspects, a bed platform 104 may be shown in an elevated position, ready to be secured to the track rails 102 by brackets 110. The brackets 110 may engage with the openings on the track rails 102, thereby providing a mechanism for the adjustable positioning of the bed platform 104. The bed platform 104 may be designed to support a mattress 106 (not shown in the figure), indicating its potential use for sleeping arrangements. However, in other cases, the bed platform 104 may be used for other purposes, such as a desk or work surface when a mattress 106 is not placed upon it. This demonstrates the versatility and adaptability of the bed system 100, as it can be reconfigured to serve multiple functions based on the user's requirements.

Additionally, support channels 112 may be connected to the brackets 110 and provide additional structural support to the bed platform 104. The support channels 112 may be designed to engage with the brackets 110, thereby providing a secure connection between the brackets 110 and the bed platform 104. The arrangement of the track rails 102, brackets 110, and support channels 112 allows for the vertical adjustability of the bed platform 104 within the space. This feature provides flexibility in configuring the interior space of the recreational vehicle R, allowing for customization based on the user's preferences or requirements.

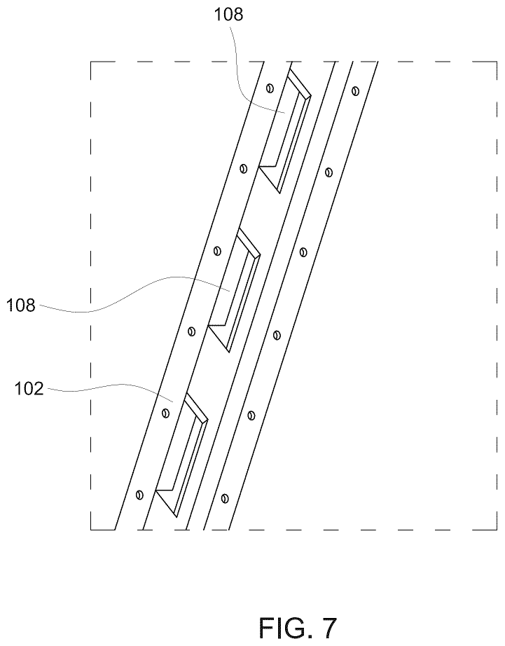

Referring now to FIG. 7, an orthogonal view of a section of a track rail 102 is depicted. The track rail 102 may be designed to be mounted vertically on a wall W of a recreational vehicle R. The track rail 102 may feature multiple rail openings 108 that are evenly spaced along the length of the track rail 102. The rail openings 108 are designed to receive brackets or other securing mechanisms for a modular bed system 100.

In some aspects, the rail openings 108 are a central feature of the adjustability and modularity of the bed system 100. The rail openings 108 allow for the attachment of components, such as brackets 110 or other securing mechanisms, at various heights along the track rail 102. This feature provides flexibility in configuring the interior space of the recreational vehicle R, allowing for customization based on the user's preferences or requirements.

For instance, the bed platform 104 can be positioned at a height suitable for use as a single bed. Alternatively, the bed system 100 may include multiple bed platforms 104, each designed to support a mattress 106, thereby providing a double bed configuration. The ability to adjust the positioning of the bed platform 104 along the track rails 102 allows for customization of the bed system 100 based on the user's preferences or requirements.

In other cases, the bed platform 104 may be used for other purposes, such as a desk or work surface when a mattress 106 is not placed upon it. This demonstrates the versatility and adaptability of the bed system 100, as it can be reconfigured to serve multiple functions based on the user's requirements.

The track rail 102, with its series of aligned openings including the rail opening 108, provides the structural foundation for the adjustable bracket 110, enabling the customization of bed platform 104 heights and configurations within a recreational vehicle R or similar environment.

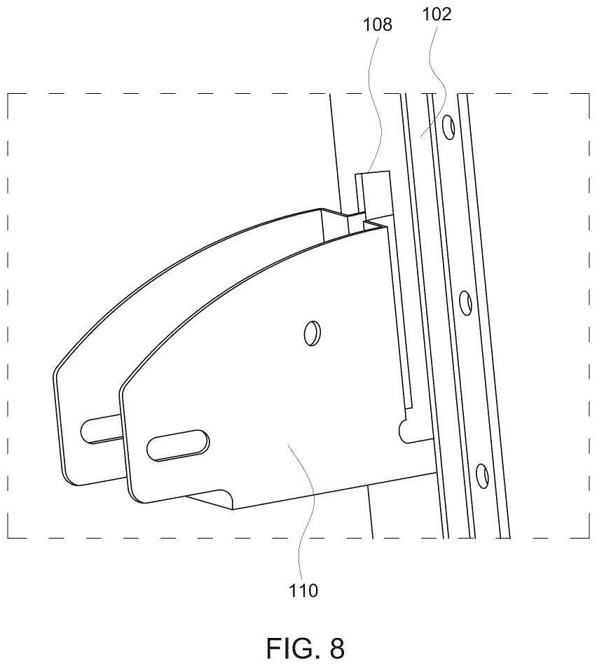

Referring now to FIG. 8, an isometric view of a bracket 110 engaged with a track rail 102 is depicted. The bracket 110 is inserted into a rail opening 108 of the track rail 102, illustrating the mechanism by which components such as bed platforms 104 can be secured at various heights within a modular bed system 100. The track rail 102 provides a series of aligned openings, including the rail opening 108, which accommodate the bracket 110, enabling the adjustable and secure attachment of the bracket 110 to the track rail 102.

In some aspects, the bracket 110 may include two fixed position outer prongs and a pivotable or rotatable middle prong. The pivotable or rotatable middle prong may be biased into a position close to the fixed position prongs, but can be manually pulled away or pivoted away from the fixed position prongs to allow the bracket 110 to be secured into one of the rail openings 108 in the track rail 102. Once the bracket 110 is positioned within the rail opening 108, the pivotable or rotatable middle prong may be released, returning back to its biased position close to the fixed position prongs, thereby locking the bracket 110 into the rail opening 108 in the track rail 102.

In some cases, the bracket 110 may be designed to support a bed platform 104 at a desired height. The bracket 110 may be secured into any of the rail openings 108 in the track rail 102, allowing for the vertical adjustability of the bed platform 104. This feature provides flexibility in configuring the interior space of a recreational vehicle R, allowing for customization based on the user's preferences or requirements. For instance, the bed platform 104 may be positioned at a height suitable for use as a single bed or a double bed, or it may be used as a desk or work surface when a mattress 106 is not placed upon it. This demonstrates the versatility and adaptability of the bed system 100, as it can be reconfigured to serve multiple functions based on the user's requirements.

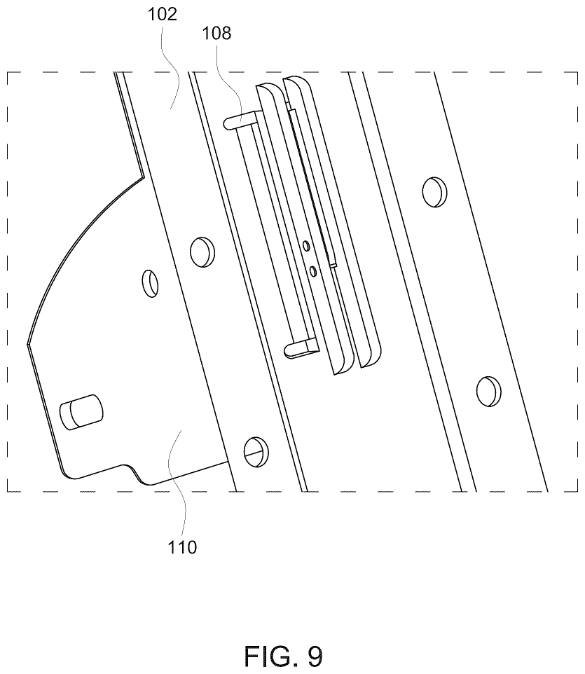

Referring now to FIG. 9, a partial isometric view of a track rail 102 engaged with a bracket 110 is depicted. The bracket 110 is inserted into a rail opening 108 of the track rail 102, illustrating the connection mechanism that allows for the secure attachment and adjustment of components within a modular bed system 100. The track rail 102, with its series of aligned openings including the rail opening 108, provides the structural foundation for the adjustable bracket 110, enabling the customization of bed platform heights and configurations within a recreational vehicle R or similar environment.

In some aspects, the bracket 110 may be designed to engage with the rail openings 108 on the track rail 102, thereby providing a secure connection between the track rail 102 and the bed platform 104. The bracket 110 may include upper and lower extensions that hook into any of the rail openings 108 in the track rail 102. Once the bracket 110 is positioned within the rail opening 108, it may be locked into place, thereby securing the bed platform 104 at a desired height.

In some cases, the bed platform 104 may be positioned at a height suitable for use as a single bed. Alternatively, the bed system 100 may include multiple bed platforms 104, each designed to support a mattress 106, thereby providing a double bed configuration. The ability to adjust the positioning of the bed platform 104 along the track rails 102 allows for customization of the bed system 100 based on the user's preferences or requirements. For instance, the bed platform 104 may be positioned at a height suitable for use as a desk or work surface when a mattress 106 is not placed upon it. This demonstrates the versatility and adaptability of the bed system 100, as it can be reconfigured to serve multiple functions based on the user's requirements.

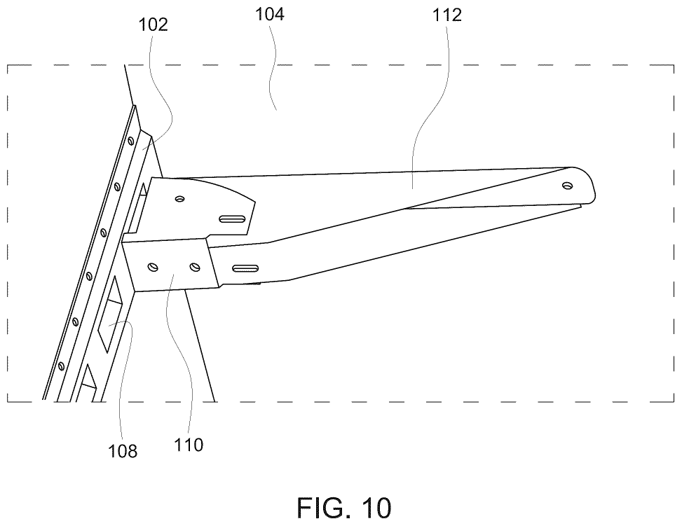

Referring now to FIG. 10, an isometric view of a component of a reconfigurable, modular bed system 100 is depicted. The bed system 100 may include track rails 102 that are designed to be mounted vertically on a wall W of a recreational vehicle R. The track rails 102 may feature multiple rail openings 108 that are designed to receive brackets 110. The brackets 110 may be designed to engage with the rail openings 108 on the track rails 102, thereby providing a secure connection between the track rails 102 and the bed platform 104.

In some aspects, the bracket 110 may be connected to a support channel 112, which in turn supports a bed platform 104. This configuration illustrates how the bed platform 104 can be securely attached to the track rails 102 at a desired height, providing a stable and adjustable foundation for the bed system 100. The support channel 112 may be designed to engage with the bracket 110, thereby providing a secure connection between the bracket 110 and the bed platform 104.

The brackets 110 and the support channels 112 can be secured together using any suitable type of fasteners or mechanisms. This includes, but is not limited to, bolts, screws, or other conventional fastening means known in the art, which provide a secure and stable connection suitable for the intended use within a recreational vehicle R. Additionally, in some embodiments, the bracket 110 and support channel 112 can be a single integrally-formed piece, offering a streamlined design and potentially reducing the number of components and complexity of assembly.

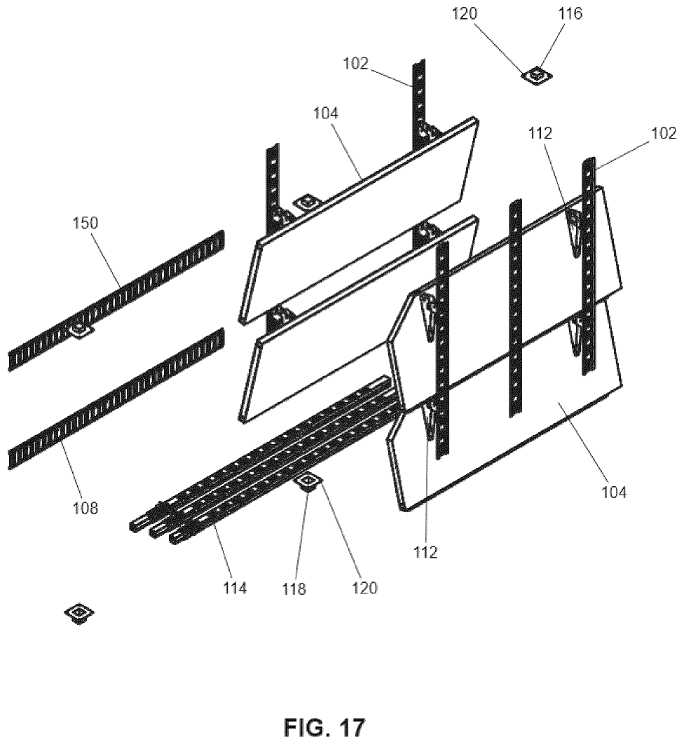

Optionally, the bracket 110 and the support channel 112 may include a plurality of aligned holes. These holes are designed to receive one or more pins or bolts (not shown) that extend through both the bracket 110 and the support channel 112, thereby securing the two pieces together. Preferably, one or more bolts or pins are utilized to ensure a robust and stable connection. Additionally, this configuration allows for a pivoting action; when at least one bolt or pin is removed, the support channel 112 is capable of pivoting with respect to the bracket 110 about the axis of the remaining bolt or pin. This feature provides added versatility in the adjustment and positioning of the bed platform 104, facilitating easier installation, reconfiguration, or stowing of the bed system (as shown in FIG. 17) as may be desired in various use scenarios within the recreational vehicle R. In instances in which a single pin or bolt is used to secure the support channel 112 to the bracket 110, then it may be possible to remove the bolt, pivot the support channel 112 to a second orientation, and then reinsert the bolt through a different set of aligned holes, such as to secure the support channel 112 and the supported bed platform 104 into a downward stowed position.

This integrated approach may enhance the structural integrity and ease of installation of the bed system. The arrangement of the track rails 102, bracket 110, and support channel 112 allows for the vertical adjustability of the bed platform 104 within the space. This feature provides flexibility in configuring the interior space of the recreational vehicle R, allowing for customization based on the user's preferences or requirements.

In some cases, the bed platform 104 may be positioned at a height suitable for use as a single bed. Alternatively, the bed system 100 may include multiple bed platforms 104, each designed to support a mattress 106 (not shown in the figure), thereby providing a double bed configuration. The ability to adjust the positioning of the bed platform 104 along the track rails 102 allows for customization of the bed system 100 based on the user's preferences or requirements. For instance, the bed platform 104 may be positioned at a height suitable for use as a desk or work surface when a mattress 106 is not placed upon it. This demonstrates the versatility and adaptability of the bed system 100, as it can be reconfigured to serve multiple functions based on the user's requirements.

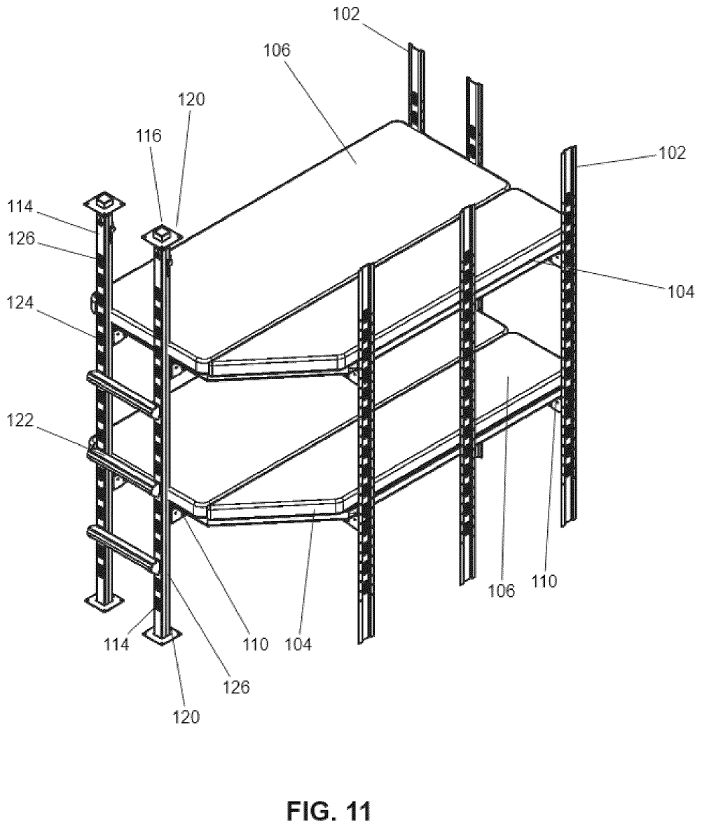

Referring now to FIG. 11, an isometric view of a modular bed system 100 with vertically stacked bed platforms 104 is depicted. The bed system 100 may include track rails 102 that are mounted vertically and feature multiple rail openings 108 for attaching brackets 110. The brackets 110 may support the bed platforms 104 at different heights. Mattresses 106 may rest on top of the bed platforms 104, indicating their use for sleeping arrangements.

In some aspects, columns 114 may be positioned at the ends of the bed platforms 104 and are secured within ceiling sockets 116 with metal plates 120, providing additional support. The columns 114 may extend partially upwardly toward the ceiling, but may extend up to the height of the bed platform 104 which functions as a desk or a table. The columns 114 may include the aligned openings discussed elsewhere herein with respect to the track. A bracket 110 may be secured into vertically-aligned column openings 124 on each of the columns 114, and there may be additional bed support channels 112 secured to each of the brackets 110 to support the bed platform 104.

In some cases, ladder rungs 122 may extend horizontally between the columns 114, enhancing the structural stability of the system. It is understood that one or more ladder rungs 122 may be utilized by a user to climb up to a top bed platform 104. Each column 114 may have column openings 124 for the attachment of brackets 110 or other components such as an end of the ladder rung 122, and an adjustable post 126 may allow for height customization of the columns 114. It is to be understood that each end of the ladder rung 122 may be secured into the column openings 124 in the same manner as the brackets 110, as described elsewhere herein.

In some embodiments, the vertical columns 114 may be used to support the bed platform 104 instead of the wall-mounted track rails 102. This configuration may provide even greater adjustability in configurations that can be made by the user within the recreational vehicle R. Bed platforms 104 can selectively be placed at a multitude of different positions or locations as desired. Alternatively, the bed platforms 104 and columns 114 can be removed entirely as desired by the user, such as when the recreational vehicle R is being driven (or towed, in the case of a towable recreational vehicle), to create large interior storage space within the recreational vehicle R.

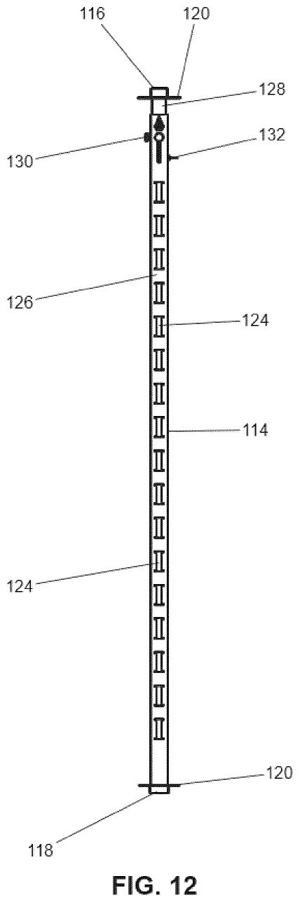

Referring now to FIG. 12, an orthogonal front view of a vertical column 114 for a modular bed system 100 is depicted. The column 114 is designed to extend between a ceiling socket 116 and a floor socket 118, with metal plates 120 at both ends to secure the column 114 in place. Preferably the metal plates 120 are integrally formed with the ceiling socket 116 and the floor socket 118, in which the metal plates 120 extend outwardly from an upper perimeter of the ceiling socket 116 and the floor socket 118. In this instance, the metal plates 120 can include holes for receiving a fastener (not shown), such as a screw, which can be inserted through the holes and secured firmly into the floor of the recreational vehicle R. The column 114 may be an elongated post which may have a hollow interior. The column 114 may include multiple column openings 124, which allow for the attachment of brackets 110 or other components to support bed platforms 104 or other structures at various heights.

In some aspects, an inner post 128 may be adjustable within the column 114 and can be fixed at the desired height using a thumbwheel 130 and a pin 132. The inner post 128 may slide upward or downward within the column 114 to selectively adjust the height of the column 114. The inner post 128, thumbwheel 130, and pin 132 work together to provide a secure and adjustable support system within the recreational vehicle R environment.

The lower end of the column 114 may be secured within a socket, opening, or recess within the floor socket 118 of the recreational vehicle R. Likewise, the upper end of the inner post 128 may be complementary and sized to fit within the opening of the column 114. The upper end of the inner post 128 may be configured to be secured within a socket, opening, or recess within the ceiling socket 116 of the recreational vehicle R.

The socket or recess within both the ceiling socket 116 and the floor socket 118 of the recreational vehicle R may be sized to receive the respective lower end and upper end of the column 114. The socket or recess can include a metal plate 120 that is secured to the ceiling socket 116 or floor socket 118 of the recreational vehicle R. The metal plate 120 may include an opening that is sized and dimensioned to snugly receive the upper end or lower end of the column 114, whereby the column 114 is retained firmly in place within the sockets 116, 118 when installed.

In some cases, any suitable type of mechanism can be used to secure the inner post 128 within the column 114 at any desired position to set the height of the column 114 as desired. For example, the column 114 can include one or more vertical slots which are aligned with a threaded hole in the inner post 128. A threaded thumbwheel 130 or screw can be inserted from the exterior, through the slot, and into the threaded hole of the inner post 128. Once the height or position of the inner post 128 is desired, then the thumbwheel 130 can be rotated to thread the thumbwheel 130 into the threaded hole and tightly against the column 114.

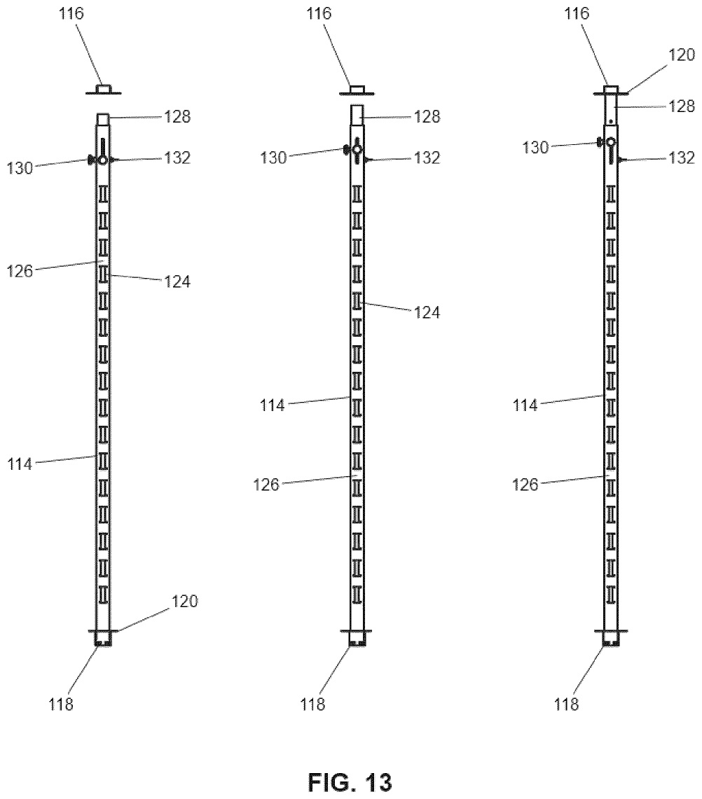

Referring now to FIG. 13, orthogonal front views of a vertical column 114 for a modular bed system 100 are depicted, showing the adjustable inner post 128 at three different heights. The leftmost view shows the column 114 with the inner post 128 at its lowest height, the center view shows the column 114 with the inner post 128 at a middle height, and the rightmost view shows the column 114 with the inner post 128 at its tallest height.

The inner post 128 is adjustable within the column 114 and can be fixed at the desired height using a thumbwheel 130. The thumbwheel 130 is used to adjust the height of the inner post 128, which fits into a ceiling socket 116 secured to the ceiling by a metal plate 120. The column 114 features multiple column openings 124, allowing for the attachment of brackets 110 or other components to support bed platforms 104 or other structures at various heights.

The lower end of the column 114 is designed to fit into the floor socket 118, which is secured to the floor by another metal plate 120. The pin 132, shown in the center and rightmost views, is used to lock the inner post 128 at the desired height, ensuring the column 114 is securely held between the ceiling and floor sockets 116, 118.

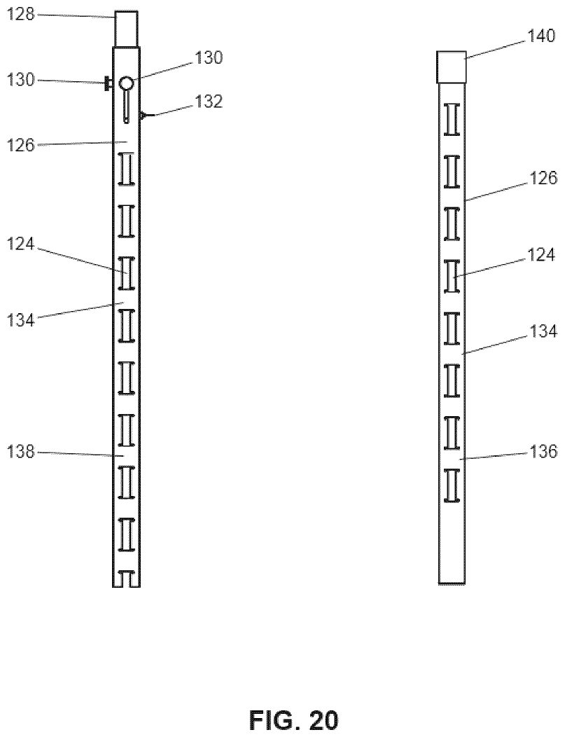

In some aspects, and as shown in FIG. 20, the vertical columns 114 can include a separate upper post 138 and lower post 136, held together by a collar 140. This configuration allows for the column 114 to be used at full height or as a half-height column when the lower post 136 is utilized. This provides additional flexibility in configuring the bed system 100, allowing for customization based on the user's preferences or requirements.

In other cases, the vertical columns 114 can be adjusted in height using a thumbwheel 130 and a pin 132. The thumbwheel 130 and pin 132 work together to provide a secure and adjustable support system within the recreational vehicle R environment. This feature allows for the vertical adjustability of the bed platforms 104 within the space, providing flexibility in configuring the interior space of the recreational vehicle R.

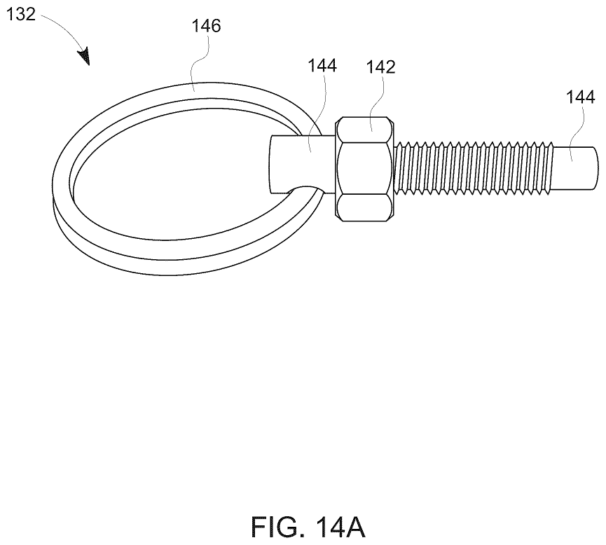

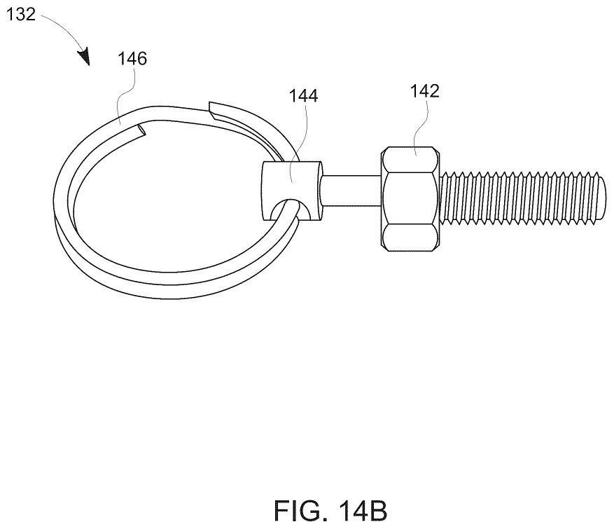

Referring now to FIG. 14A, an isometric view of a spring pin 132 is depicted. The spring pin 132 may include a threaded housing 142 that encloses a plunger 144, which is connected to a pull ring 146. In some aspects, a spring (not shown) may also be located within the threaded housing 142, and the spring may bias the plunger 144 in the position as shown in the figure. The pull ring 146 may allow for manual retraction of the plunger 144 from the threaded housing 142, enabling the spring pin 132 to engage with or disengage from other components within a modular bed system 100. The interaction between the threaded housing 142, plunger 144, and pull ring 146 may facilitate the secure and adjustable connection of the spring pin 132 to the system's components. This feature may provide additional flexibility in configuring the bed system 100, allowing for customization based on the user's preferences or requirements.

Referring now to FIG. 14B, an isometric view of a spring pin 132 is depicted. The spring pin 132 comprises a threaded housing 142 that encloses a plunger 144, which is connected to a pull ring 146. The threaded housing 142 also houses a spring (not shown), and the figure shows the position of the plunger 144 within the threaded housing 142 when the biasing force of the spring has been overcome. The pull ring 146 facilitates manual retraction of the plunger 144 from the threaded housing 142, enabling the spring pin 132 to engage with or disengage from other components within a modular bed system 100. The configuration of the spring pin 132 with its threaded housing 142, plunger 144, and pull ring 146 allows for secure and adjustable connections within the system.

In some aspects, the spring pin 132 may be used to secure the inner post 128 within the column 114 at any desired position to set the height of the column 114 as desired. For example, the column 114 can include one or more vertical slots which are aligned with a threaded hole in the inner post 128. A threaded thumbwheel 130 or screw can be inserted from the exterior, through the slot, and into the threaded hole of the inner post 128. Once the height or position of the inner post 128 is desired, then the thumbwheel 130 can be rotated to thread the thumbwheel 130 into the threaded hole and tightly against the column 114. The spring pin 132 provides a secure and adjustable connection, allowing for the vertical adjustability of the bed platforms 104 within the space, providing flexibility in configuring the interior space of a recreational vehicle R.

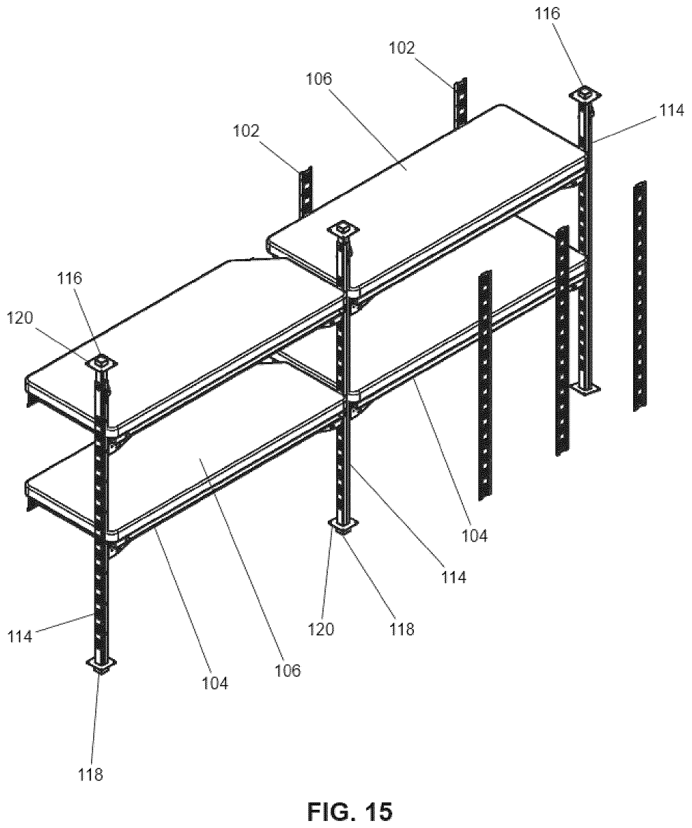

Referring now to FIG. 15, an isometric view of a modular bed system 100 is depicted. The bed system 100 may include track rails 102 that are mounted vertically and feature multiple rail openings 108 for attaching brackets 110. The brackets 110 may support the bed platforms 104 at different heights. Mattresses 106 may rest on top of the bed platforms 104, indicating their use for sleeping arrangements.

In some aspects, columns 114 may be positioned at the ends of the bed platforms 104 and are secured within ceiling sockets 116 and floor sockets 118, with metal plates 120 at both ends to secure the columns 114 in place. The columns 114 may extend partially upwardly toward the ceiling, but may extend up to the height of the bed platform 104 which functions as a desk or a table. The columns 114 may include the aligned openings discussed elsewhere herein with respect to the track. A bracket 110 may be secured into vertically-aligned column openings 124 on each of the columns 114, and there may be additional bed support channels 112 secured to each of the brackets 110 to support the bed platform 104.

In some cases, ladder rungs 122 may extend horizontally between the columns 114, enhancing the structural stability of the system. Each column 114 may have column openings 124 for the attachment of brackets 110 or other components, and an adjustable post 126 may allow for height customization of the columns 114.

In some embodiments, the vertical columns 114 may be used to support the bed platform 104 instead of the wall-mounted track rails 102. This configuration may provide even greater adjustability in configurations that can be made by the user within the recreational vehicle R. Bed platforms 104 can selectively be placed at a multitude of different positions or locations as desired. Alternatively, the bed platforms 104 and columns 114 can be removed entirely as desired by the user, such as when the recreational vehicle R is being driven (or towed, in the case of a towable recreational vehicle), to create large interior storage space within the recreational vehicle R.

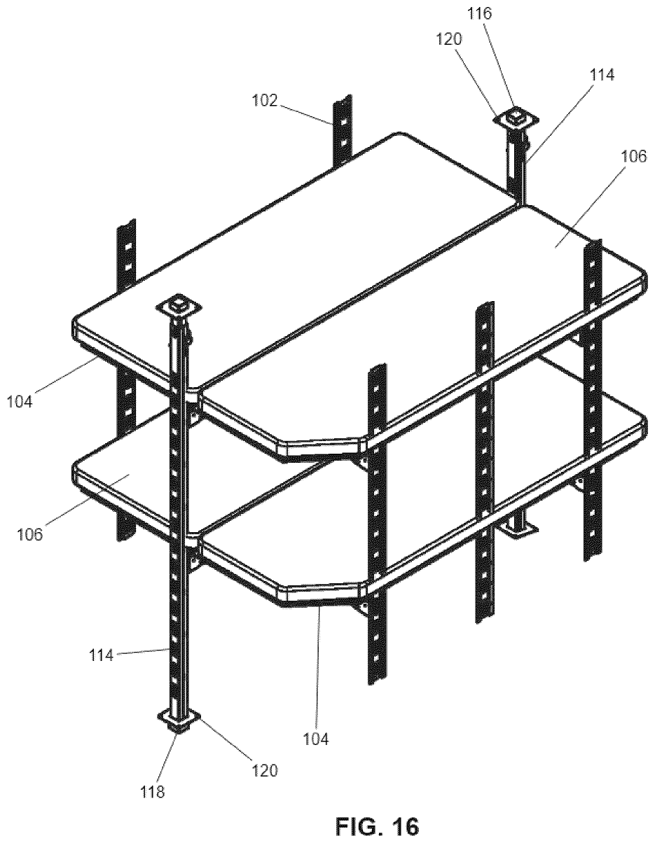

Referring now to FIG. 16, an isometric view of a stacked double bed configuration within a modular bed system 100 is depicted. The bed system 100 may include track rails 102 that are mounted vertically and support bed platforms 104 at two different heights. Mattresses 106 may be placed on top of each bed platform 104, indicating their use for sleeping arrangements.

In some aspects, columns 114 may be positioned at the ends of the bed platforms 104 and are secured within ceiling sockets 116 and floor sockets 118, with metal plates 120 at both ends to secure the columns 114 in place. The arrangement of the track rails 102, bed platforms 104, mattresses 106, columns 114, ceiling sockets 116, floor sockets 118, and metal plates 120 demonstrates the system's modularity and ability to accommodate different sleeping arrangements within a space.

In some cases, the vertical columns 114 may be used to support the bed platform 104 instead of the wall-mounted track rails 102. This configuration may provide even greater adjustability in configurations that can be made by the user within the recreational vehicle R. Bed platforms 104 can selectively be placed at a multitude of different positions or locations as desired. Alternatively, the bed platforms 104 and columns 114 can be removed entirely as desired by the user, such as when the recreational vehicle R is being driven (or towed, in the case of a towable recreational vehicle), to create large interior storage space within the recreational vehicle R.

Referring now to FIG. 17, an exploded isometric view of a reconfigurable, modular bed system 100 is depicted. The bed system 100 is shown in a stowed-away configuration in which the bed platforms 104 are angled downwardly from the track rails 102 and the columns 114 have been removed and are placed on the floor.

The bed platforms 104 are positioned at different heights, each connected to support channels 112, which are designed to engage with the track rails 102. The support channels 112 provide additional structural support to the bed platforms 104, enhancing the stability of the bed system 100.

The columns 114 are illustrated at the lower end of the bed platforms 104, intended to be secured within floor sockets 118, which are anchored by metal plates 120. The lower end of the columns 114 is designed to fit into the floor socket 118, which is secured to the floor by a metal plate 120. This configuration provides a secure and stable base for the columns 114, ensuring that they remain firmly in place when installed.

Ceiling sockets 116, also accompanied by metal plates 120, are depicted at the upper end, indicating where the top of the columns 114 would be secured to complete the assembly. The upper end of the columns 114 is designed to fit into the ceiling socket 116, which is secured to the ceiling by a metal plate 120. This configuration provides a secure and stable top end for the columns 114, ensuring that they remain firmly in place when installed.

The arrangement of the track rails 102, bed platforms 104, support channels 112, columns 114, ceiling sockets 116, floor sockets 118, and metal plates 120 demonstrates the system's modularity and the process of assembling the bed system 100 within a space. This feature provides flexibility in configuring the interior space of a recreational vehicle R, allowing for customization based on the user's preferences or requirements.

In some cases, the bed platforms 104 and columns 114 can be removed entirely as desired by the user, such as when the recreational vehicle R is being driven (or towed, in the case of a towable recreational vehicle), to create large interior storage space within the recreational vehicle R. This demonstrates the versatility and adaptability of the bed system 100, as it can be reconfigured to serve multiple functions based on the user's requirements.

Also shown in FIG. 17 is a horizontal track system 150 which can be included in lieu of or as an optional addition to the vertical track system 102 to offer enhanced flexibility and customization of the bed platform 104 positioning. The horizontal track system 150, while maintaining the wall-mounted feature and the plurality of aligned openings 108 characteristic of the vertical track system, is mounted horizontally along the wall W. The openings 108 on the horizontal track system are rotated 90 degrees to ensure that they are oriented identically to those on the vertical track system 102 once mounted onto the wall W, thus allowing the brackets 110 to be received at the same orientation. The incorporation of this horizontal track system 150 alongside the vertical track system 102 provides users with the option to secure and adjust bed platforms 104 in multiple orientations, catering to a wider range of spatial configurations within the recreational vehicle R.

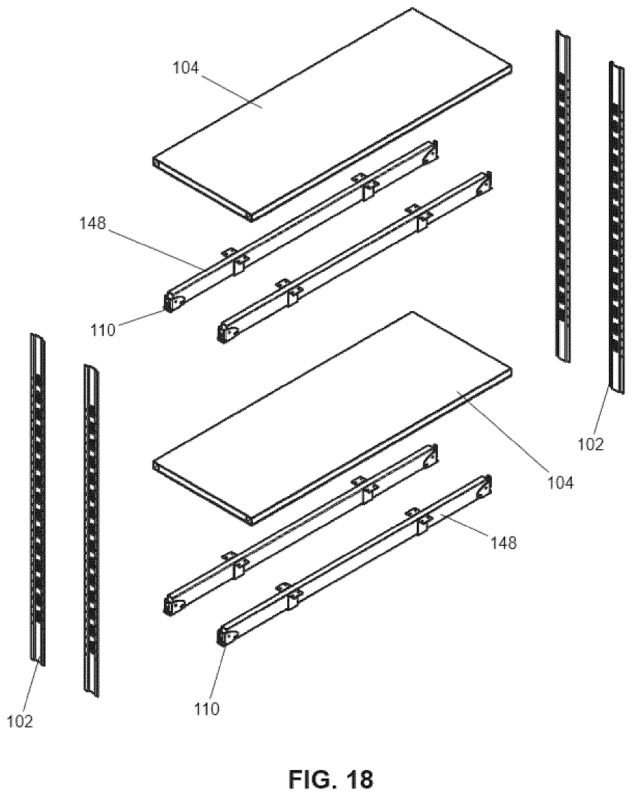

Referring now to FIG. 18, an exploded isometric view of a modular bed system component is depicted. The bed system 100 may include track rails 102 that are designed to be mounted vertically on a wall W of a recreational vehicle R. The track rails 102 may feature multiple rail openings 108 that are designed to receive brackets 110. The brackets 110 may be designed to engage with the rail openings 108 on the track rails 102, thereby providing a secure connection between the track rails 102 and the bed platform 104.

In some aspects, two bed platforms 104 may be shown in an elevated position, ready to be secured to the track rails 102 by brackets 110. The brackets 110 may engage with the openings on the track rails 102, thereby providing a mechanism for the adjustable positioning of the bed platforms 104.

In addition to the brackets 110, beams 148 may be positioned between the brackets 110 and provide structural support for the bed platforms 104. In some cases, the bed platform 104 can be supported by a beam 148 that extends the full span between each aligned track rail 102. This configuration may provide additional structural support to the bed platform 104, enhancing the stability of the bed system 100. The arrangement of the track rails 102, brackets 110, beams 148, and bed platforms 104 demonstrates the system's modularity and the process of assembling the bed system 100 within a space. This feature provides flexibility in configuring the interior space of a recreational vehicle R, allowing for customization based on the user's preferences or requirements.

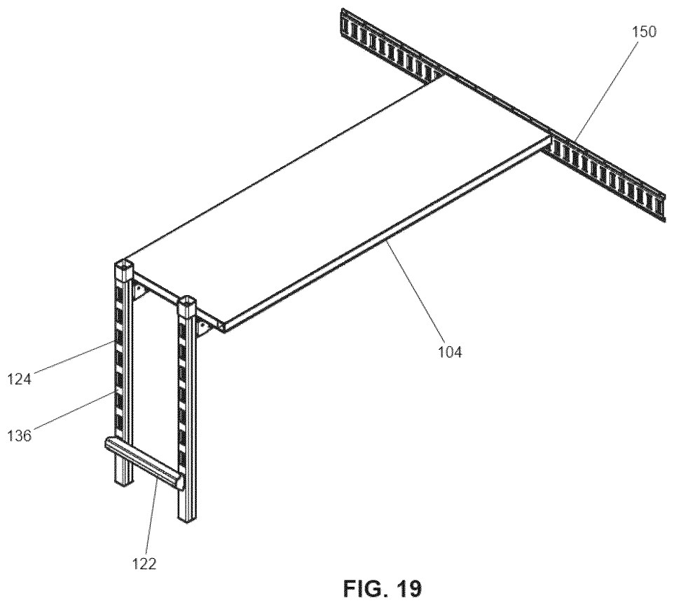

Referring now to FIG. 19, an isometric view of a portion of a reconfigurable, modular bed system 100 is depicted. In this configuration, a bed platform 104 is supported at one end by a wall-mounted horizontally-oriented track rail 150 and at the other end by a lower post 136. The lower post 136, which may be a section of a column 114, features column openings 124 for the attachment of brackets or other securing mechanisms.

The track rail 150 and the lower post 136 together facilitate the adjustable positioning and secure mounting of the bed platform 104 within a recreational vehicle R or similar environment. The track rail 150, which may be horizontally oriented and affixed to a wall W of the recreational vehicle R, features multiple rail openings 108 that are designed to receive brackets 110. The brackets 110 are designed to engage with the rail openings 108 on the track rail 150, thereby providing a secure connection between the track rail 150 and the bed platform 104.

A rung 122 extends horizontally between two sections of the lower post 136, providing additional structural support and stability to the bed platform 104. The rung 122 may be secured to the lower post 136 at any desired height, providing flexibility in configuring the bed system 100. The rung 122 may also serve as a step or foothold, facilitating access to the bed platform 104 when it is positioned at an elevated height.

In some cases, the bed platform 104 may be positioned at a height suitable for use as a single bed. Alternatively, the bed system 100 may include multiple bed platforms 104, each designed to support a mattress (not shown in the figure), thereby providing a double bed configuration. The ability to adjust the positioning of the bed platform 104 along the track rails 102 and the lower post 136 allows for customization of the bed system 100 based on the user's preferences or requirements. For instance, the bed platform 104 may be positioned at a height suitable for use as a desk or work surface when a mattress is not placed upon it. This demonstrates the versatility and adaptability of the bed system 100, as it can be reconfigured to serve multiple functions based on the user's requirements.

Referring now to FIG. 20, orthogonal front views of a two-piece column 134 for a modular bed system 100 are depicted. The two-piece column 134 consists of an upper post 138 connected to a lower post 136 by a collar 140. The upper post 138 houses an inner post 128 that can be adjusted in height using a thumbwheel 130. A pin 132 is also present to lock the inner post 128 at the desired height.

In some aspects, the upper post 138 of the two-piece column 134, as shown on the left of FIG. 20, features an inner post 128 that can be adjusted in height using a thumbwheel 130. The thumbwheel 130 is used to adjust the height of the inner post 128, which fits into a ceiling socket 116 secured to the ceiling by a metal plate 120. The upper post 138 features multiple column openings 124, allowing for the attachment of brackets 110 or other components to support bed platforms 104 or other structures at various heights.

The lower post 136 of the two-piece column 134, as shown on the right of FIG. 20, is designed to be connected to the upper post 138 using a collar 140. Both the upper post 138 and the lower post 136 have multiple column openings 124, allowing for the attachment of brackets or other components to support bed platforms 104 or other structures at various heights.

The lower end of the column 114 is designed to fit into the floor socket 118, which is secured to the floor by another metal plate 120. The pin 132, shown in the center and rightmost views, is used to lock the inner post 128 at the desired height, ensuring the column 114 is securely held between the ceiling and floor sockets 116, 118.

In some aspects, the vertical columns 114 can include a separate upper post 138 and lower post 136, held together by a collar 140. This configuration allows for the column 114 to be used at full height or as a half-height column when the lower post 136 is utilized. This provides additional flexibility in configuring the bed system 100, allowing for customization based on the user's preferences or requirements.

In other cases, the vertical columns 114 can be adjusted in height using a thumbwheel 130 and a pin 132. The thumbwheel 130 and pin 132 work together to provide a secure and adjustable support system within the recreational vehicle R environment. This feature allows for the vertical adjustability of the bed platforms 104 within the space, providing flexibility in configuring the interior space of the recreational vehicle R.

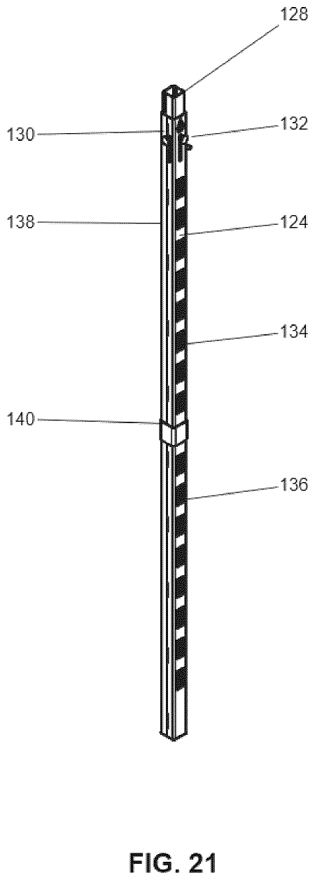

Referring now to FIG. 21, an orthogonal front view of a two-piece column 134 for a modular bed system 100 is depicted. The two-piece column 134 consists of an upper post 138 connected to a lower post 136 by a collar 140. The upper post 138 houses an inner post 128 that can be adjusted in height using a thumbwheel 130. A pin 132 is also present to lock the inner post 128 at the desired height.

In some aspects, the upper post 138 of the two-piece column 134 may feature an inner post 128 that can be adjusted in height using a thumbwheel 130. The thumbwheel 130 may be used to adjust the height of the inner post 128, which fits into a ceiling socket 116 secured to the ceiling by a metal plate 120. The upper post 138 may feature multiple column openings 124, allowing for the attachment of brackets 110 or other components to support bed platforms 104 or other structures at various heights.

The lower post 136 of the two-piece column 134, as shown in FIG. 21, may be designed to be connected to the upper post 138 using a collar 140. Both the upper post 138 and the lower post 136 may have multiple column openings 124, allowing for the attachment of brackets 110 or other components to support bed platforms 104 or other structures at various heights.

The lower end of the two-piece column 134 may be designed to fit into the floor socket 118, which may be secured to the floor by a metal plate 120. The pin 132, shown in FIG. 21, may be used to lock the inner post 128 at the desired height, ensuring the two-piece column 134 is securely held between the ceiling and floor sockets 116, 118.

In some aspects, the vertical two-piece column 134 can include a separate upper post 138 and lower post 136, held together by a collar 140. This configuration allows for the two-piece column 134 to be used at full height or as a half-height column when the lower post 136 is utilized. This provides additional flexibility in configuring the bed system 100, allowing for customization based on the user's preferences or requirements.

In other cases, the vertical two-piece column 134 can be adjusted in height using a thumbwheel 130 and a pin 132. The thumbwheel 130 and pin 132 work together to provide a secure and adjustable support system within the recreational vehicle R environment. This feature allows for the vertical adjustability of the bed platforms 104 within the space, providing flexibility in configuring the interior space of the recreational vehicle R.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A reconfigurable, modular bed system for use in recreational vehicles, comprising:
a plurality of bed platforms configured to support a mattress;
a vertically-oriented track system secured to one or more walls in the recreational vehicle, the track system comprising a plurality of vertical tracks having a plurality of aligned openings;
a plurality of brackets having upper and lower extensions for hooking into any of the openings in the vertical tracks; and
a plurality of bed support channels, each of the plurality of bed support channels being secured to a respective bracket from the plurality of brackets to support the plurality of bed platforms,
wherein the plurality of bed platforms can be repositioned or removed as desired.

2. The reconfigurable, modular bed system of claim 1, wherein the bed platforms are vertically adjustable along the track system to accommodate different user requirements.

3. The reconfigurable, modular bed system of claim 1, wherein the brackets are designed to securely fasten the bed platforms to the track system at any of the aligned openings, allowing for easy repositioning or removal of the bed platforms.

4. The reconfigurable, modular bed system of claim 1, wherein the bed platforms are configured to support a double bed configuration, offering further adaptability to the user's sleeping arrangement preferences.

5. The reconfigurable, modular bed system of claim 1, wherein the bed platforms, when the mattress is removed, can function as a work surface, providing a more efficient use of space within the recreational vehicle.

6. The reconfigurable, modular bed system of claim 1, wherein the track system, the brackets, the bed support channels, and the bed platforms are all securely fastened in place to provide stability to the bed platforms.

7. The reconfigurable, modular bed system of claim 1, wherein the bed support channels are pivotable with respect to the brackets, and the bed platforms are configured to be able to angle downwardly.

8. A reconfigurable, modular bed system for use in recreational vehicles, comprising:
a bed platform secured using a track system, the track system comprising a plurality of vertical tracks having a plurality of aligned openings;
a plurality of half-height columns to which the bed platform is secured, the half-height columns having a lower end secured into a socket in the floor of the recreational vehicle;
a bracket secured into vertically-aligned openings on each of the half-height columns;
a bed support channel being secured to each of the brackets; and
wherein the bed platform functions as a work surface and is supported by the bed support channels.

9. The reconfigurable, modular bed system of claim 8, wherein the bed platform is adjustable along the track system to accommodate different user requirements.

10. The reconfigurable, modular bed system of claim 8, wherein the half-height columns are made from metal.

11. The reconfigurable, modular bed system of claim 8 including at least one horizontal beam extending between the half-height columns to provide additional support and stability.

12. The reconfigurable, modular bed system of claim 11, wherein the horizontal beam extending between the half-height columns is removable to allow for reconfiguration of the system.

13. The reconfigurable, modular bed system of claim 8, wherein the brackets are designed to securely fasten the bed platform to the track system at any of the aligned openings, allowing for easy repositioning or removal of the bed platform.

14. The reconfigurable, modular bed system of claim 8, wherein the bed platform is configured to support a double bed configuration, offering further adaptability to the user's sleeping arrangement preferences.

15. A reconfigurable, modular bed system for use in recreational vehicles, comprising:
a bed platform secured using a track system, the track system comprising a plurality of vertical tracks having a plurality of aligned openings;
at least one vertically-oriented column, the at least one column having a plurality of aligned openings, the at least one column providing support to the bed system, and the at least one column being supported at the ceiling and the floor of the recreational vehicle;
a bracket secured into vertically-aligned openings on each of the at least one column;
a bed support channel being secured to each of the brackets; and
wherein the bed platform functions as a work surface and is supported by the bed support channels.

16. The reconfigurable, modular bed system of claim 15, wherein the columns are adjustable in height.

17. The reconfigurable, modular bed system of claim 16, wherein the columns include a separate upper section and a lower section, the upper section and the lower section being held together by a collar.

18. The reconfigurable, modular bed system of claim 17, wherein the lower section of the column functions as a half-height column when the column is configured to utilize the half height of just the lower section.

19. The reconfigurable, modular bed system of claim 15, including at least one horizontal beam extending between the columns.

20. The reconfigurable, modular bed system of claim 15, wherein the columns, the brackets, the bed support channels, and the bed platform are all securely fastened in place to provide stability to the bed platform.
